(19) United States
(12) Patent Application Publication
(10) Pub. No.: US 2005/0087251 A1
(43) Pub. Date: Apr. 28, 2005

(54) Hose

(76) Inventor: Yoshiyuki Sumitomo, Osaka (JP)

Correspondence Address: ARENT FOX KINTNER PLOTKIN & KAHN, PLLC;Suite 600, 1050 Connecticut Avenue, N.W., Washington, DC, 20036-5339, US

(21) Appl. No.: 10/691,547

(22) Filed: Oct. 24, 2003

(51) Int. Cl. F16L 9/00

(52) U.S. Cl. 138/177; 138/118; 138/115; 138/178

(57) ABSTRACT

A hose 1 has a hose body 11 of which the cross-sectional external shape as seen in a plane perpendicular to the axial direction is substantially rectangular, and has a linear projection 12 formed on the inner wall of the hose body 11 along the axial direction. To further reduce deformation of the hose 1 and thereby minimize reduction in the cross-sectional area of the fluid passage inside the hose 1 when an external force is applied thereto, the height of the linear projection 12 is preferably made equal to 50% or more of the distance from the part of the inner wall on which the linear projection 12 is formed to the part of the inner wall opposite thereto. To permit the flat wall of the hose body 11 to be supported firmly without being damaged when an external force is applied to the hose 1, the top of the linear projection 12 is preferably formed into a flat surface.

### BACKGROUND OF THE INVENTION

1. Field of the Invention

The present invention relates to a hose for conveying fluid such as water, oil, or gas.

2. Description of the Prior Art

A conventional hose designed for household use for conveying fluid such as water, oil, or gas is typically made of rubber for its easy handling and usability. When used, such a hose is so placed as to lie on a table, floor, or ground. Thus, for example as shown in FIGS. 5A and 5B, when the hose is trodden on by a human or wheel (FIG. 5A), or when it is caught at a corner of an object and thereby bent at an acute angle (FIG. 5B), the fluid passage inside the hose is obstructed at that place. This causes water or gas to leak at a place where its pressure cannot be withstood, for example where the hose is connected to a water faucet or gas outlet, or causes the hose to come off.

Moreover, a conventional hose has a circular cross section, and thus tends to be deformed greatly under an external force. This makes it quite likely that, under a relatively weak external force, the cross-sectional area of the fluid passage inside the hose becomes, not to say completely obstructed, smaller than half the area it normally has. With a gas appliance such as a gas stove or gas cooker, if the cross-sectional area of the fluid passage inside the hose supplying it diminishes by about 15% or more during its use, the fire goes out, and, for safety reasons, the appliance is designed to automatically stop operating when a predetermined length of time elapses with the fire out. To prevent this, a conventional hose designed for use with a gas appliance needs to be made of a high-strength material or reinforced with an extra material. This makes such a hose heavier and more expensive to produce than hoses designed for other purposes.

In addition, when a hose having a circular cross section is placed on a surface, it makes contact with the surface nearly at points. This results in unstable placement of the hose, allowing it to be displaced easily under a weak force. Moreover, when the hose is wound up for storage, gaps are inevitably left between different turns thereof, resulting in an extra volume for storage.

### SUMMARY OF THE INVENTION

An object of the present invention is to provide a hose of which the fluid passage inside is not completely obstructed even when the hose is trodden on by a wheel or human or bent at an acute angle.

Another object of the present invention is to provide a hose that is resistant to deformation under an external force, that is excellent in placement stability, and that can be wound up for storage without producing dead gaps between different turns thereof, contributing to a small storage volume.

To achieve the above objects, according to the present invention, a hose has a hose body of which the cross-sectional external shape as seen in a plane perpendicular to the axial direction is substantially rectangular, and has a linear projection formed on the inner wall of the hose body along the axial direction. It should be understood that, in the present invention, a “substantially rectangular” shape denotes any shape of which the basis feature is rectangular, naturally including rectangulars with chamfered or rounded corners.

With this structure, even when the hose is trodden on by a wheel or human, or bent at an acute angle, the fluid passage inside the hose is never completely obstructed, and in addition the deformation of the hose under the external force is minimized. Moreover, since the hose body has a substantially rectangular cross-sectional external shape, when the hose is placed on a surface, it makes surface contact with the surface. This prevents the hose from being dislocated easily under a weak force, and thus contributes to excellent placement stability. Furthermore, since the hose body has a substantially rectangular cross-sectional external shape, when the hose is wound up for storage, no dead gaps are produced between different turns thereof. This helps make the storage volume smaller than for conventional hoses.

From the perspective of further reducing deformation of the hose and thereby minimizing reduction in the cross-sectional area of the fluid passage inside the hose when an external force is applied thereto, it is preferable that the linear projection be given a height equal to 50% or more of the distance from the part of the inner wall on which the linear projection is formed to the part of the inner wall opposite thereto. It should be understood that, in the present invention, the height H of the linear projection denotes the dimension from the inner wall of the hose body to the top of the linear projection (see FIG. 3A).

From the perspective of permitting the flat wall of the hose to be supported firmly without being damaged when an external force is applied thereto, it is preferable that the top of the linear projection be formed into a flat surface, and it is more preferable that the linear projection be given a trapezoidal cross-sectional shape as seen in a plane perpendicular to the axial direction. In a case where the cross-sectional external shape of the hose is rectangular, it is preferable that the linear projection be formed on a longer side.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective view of an example of a hose according to the invention;

FIG. 2 is a sectional view of the hose, illustrating how it is deformed when an external force is applied thereto from above;

FIGS. 3A to 3E are sectional views of the hose, illustrating different examples of the linear projection(s) formed on the inner wall of the hose body;

FIGS. 4A to 4D are sectional views of the linear projection, illustrating different examples of the cross-sectional shape thereof; and

FIGS. 5A and 5B are diagrams illustrating how the fluid passage is obstructed in a conventional hose.

### DESCRIPTION OF THE PREFERRED EMBODIMENTS

The inventor of the present invention conducted an intensive study in search of a way not only to prevent obstruction of the fluid passage inside a hose but also to reduce deformation of the hose and thereby minimize reduction in the cross-sectional area of the fluid passage inside the hose even when the hose is trodden on by a wheel or human or bent at an acute angle. Through the study, the inventor has found that the aim is achieved by giving the hose body a substantially rectangular cross-sectional external shape and forming a linear projection on the inner wall of the hose body along the axial direction. These findings have led the inventor to conceive the present invention. Hereinafter, the present invention will be described in detail.

One distinctive feature of a hose according to the present invention is that it has a linear projection formed on the inner wall of its hose body along the axial direction. With this structure, even when the hose is trodden on by a wheel or human, or bent at an acute angle, the linear projection formed on the inner wall of the hose body prevents opposite parts of the inner wall from making close contact with each other, and thereby surely keeps the fluid passage open.

However, simply forming a linear projection on the inner wall of the hose body of a conventional hose having a circular cross section may prevent obstruction of the fluid passage inside the hose, but cannot prevent a great reduction in the cross-sectional area of the fluid passage inside the hose resulting from application of a strong external force thereto. Thus, the inventor of the present invention conceived the idea of forming the hose body of a hose, from the beginning, into such a shape into which it is deformed when an external force is applied to the hose. On the basis of this idea, which is apparently simple but which no one has ever proposed to this date, the inventor gave the hose body of a hose a substantially rectangular cross-sectional external shape. This is another distinctive feature of a hose according to the present invention. Giving the hose body a substantially rectangular cross-sectional shape in addition to forming a linear projection on the inner wall of the hose body helps not only to prevent obstruction of the fluid passage inside the hose but also to greatly alleviate reduction in the cross-sectional shape of the fluid passage.

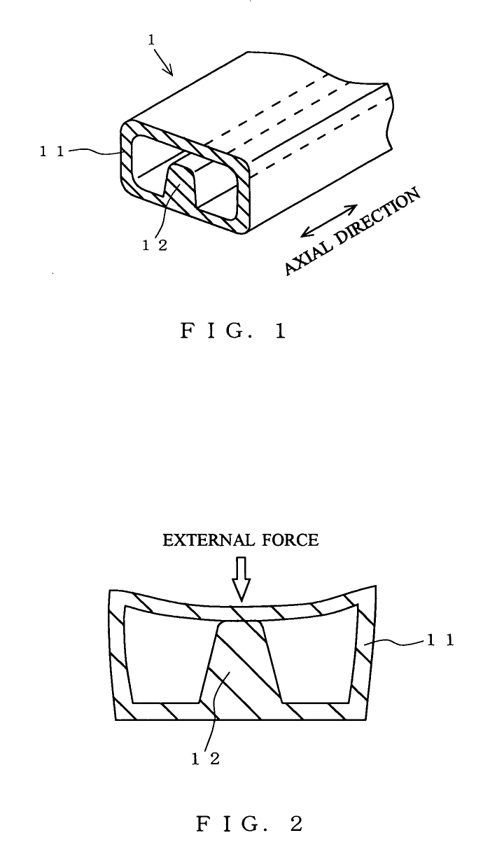

FIG. 1 is a perspective view of an example of a hose according to the present invention. The hose 1 has a hose body 11 of which the cross-sectional external shape is substantially rectangular, and has a linear projection 12 formed integrally on the inner wall of the hose body 11 so as to run continuously along the axial direction. FIG. 2 is a sectional view of the hose 1, illustrating how it is deformed when an external force is applied to part thereof from above. As will be understood from FIG. 2, when an external force is applied to the hose according to the present invention, the linear projection 12 formed on the inner wall of the hose body 11 makes contact with the part of the inner wall opposite thereto, and thereby keeps the fluid passage inside the hose open so that it is not obstructed. Moreover, the substantially rectangular cross-sectional external shape helps reduce the deformation under the external force.

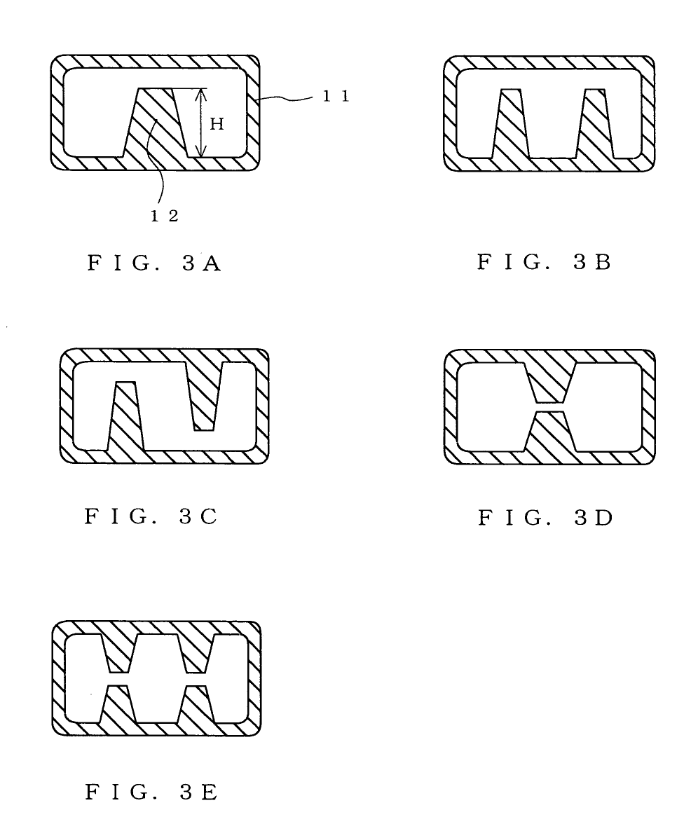

There is no particular restriction on the number of linear projections formed in a hose according to the present invention; there may be formed only one, or two or more, linear projections. There is no particular restriction on where on the inner wall of the hose body a linear projection should be formed, although it is preferable that one be formed on that part of the inner wall where an external force is likely to be applied when the hose is used and another on the part of the inner wall opposite to that part thereof. Thus, it is generally preferable that one linear projection be formed on the part of the inner wall located on that side of the hose at which it is placed on a surface and another on the part of the inner wall opposite to that part thereof FIGS. 3A to 3E show different examples of how the linear projection is formed. In FIG. 3A, a linear projection having a trapezoidal cross-sectional shape is formed on the inner wall, on the bottom side of a hose having a rectangular cross-sectional external shape. In FIG. 3B, two linear projections are formed on the inner wall, both on the bottom side of the hose. In FIG. 3C, two linear projections are formed at non-opposite positions on the inner wall, one on the bottom side and the other on the top side. In FIG. 3D, two linear projections are formed at opposite positions on the inner wall, one on the bottom side and the other on the top side. In FIG. 3E, four linear projections in total are formed at opposite positions on the inner wall, two on the bottom side and the other two on the top side.

In cases where no pair of linear projections is formed at opposite positions (for example, as in FIGS. 3A to 3C), to reduce deformation of the hose under an external force, it is advisable to make the linear projection 12 high. Specifically, it is preferable that the linear projection 12 be given a height equal to 50% or more of the distance from the part of the inner wall on which the linear projection 12 is formed to the part of the inner wall opposite thereto. To further reduce deformation of the hose under an external force applied from above, the linear projection 12 may be given a height as close as possible to the aforementioned distance between the opposite parts of the inner wall. However, if the linear projection 12 is so high as to make contact with the part of the inner wall opposite thereto when an external force is applied to the hose from an oblique direction (from leftward or rightward above in FIG. 2), the hose may be so deformed as to have a parallelogrammatic cross-sectional shape, greatly reducing the cross-sectional area of the fluid passage inside the hose. To avoid this, it is preferable that, between the top of the linear projection 12 and the part of the inner wall opposite thereto, there be left a gap in the range from 5% to 30%, more preferably in the range from 10% to 28%, of the aforementioned distance between the opposite parts of the inner wall.

On the other hand, in cases where a pair of linear projections is formed at opposite positions (for example, as in FIGS. 3D and 3E), it is preferable that the sum of the heights of the opposite linear projections be made equal to 50% or more of the aforementioned distance between the opposite parts of the inner wall. Moreover, for the same reason as stated above, to reduce deformation under an external force applied from an oblique direction, it is preferable that, between the tops of the opposite linear projections, there be left a gap in the range from 5% to 30%, more preferably in the range from 10% to 28%, of the aforementioned distance between the opposite parts of the inner wall.

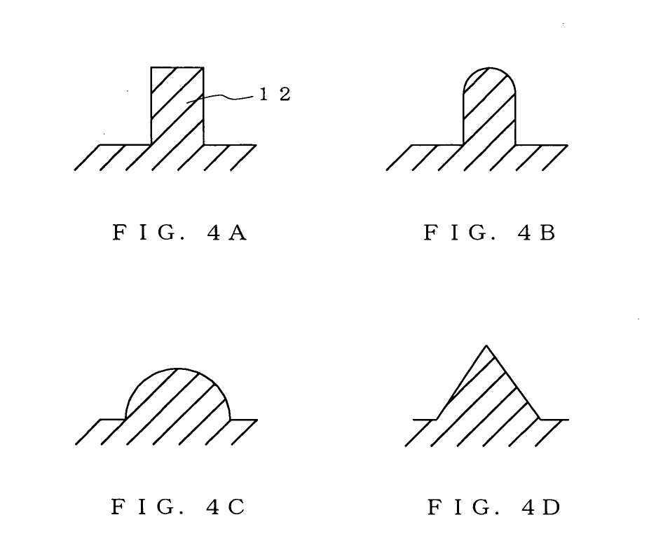

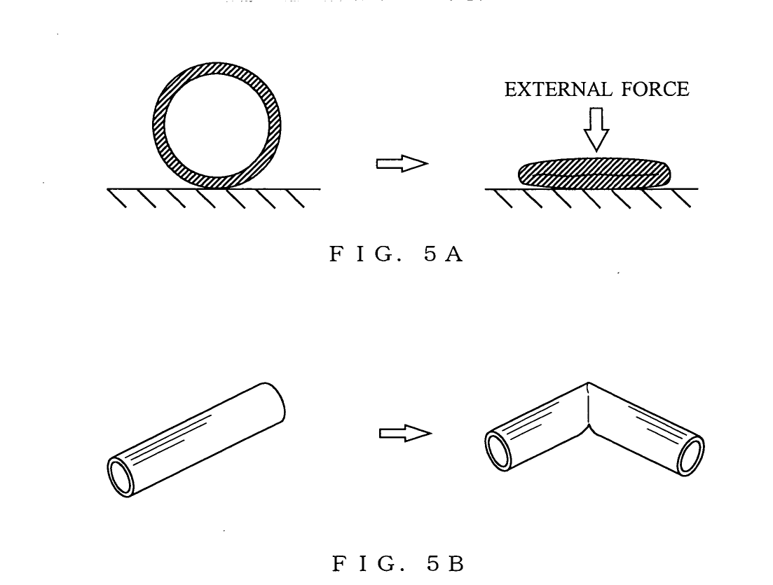

There is no particular restriction on the cross-sectional shape of the linear projection formed, so long as it is not easily deformed but keeps the fluid passage inside the hose open even under an external force. For example, the linear projection may be given, other than a trapezoidal cross-sectional shape as shown in FIGS. 2 and 3A to 3E, a rectangular (FIG. 4A), top-rounded (FIG. 4B), semicircular (FIG. 4C), or triangular (FIG. 4D) cross-sectional shape, to name a few. Among these shapes, from the viewpoint of permitting the flat wall of the hose body to be supported firmly without being damaged when an external force is applied to the hose, it is preferable that the top of the linear projection be formed into a flat surface, and it is more preferable that the linear projection be given a trapezoidal cross-sectional shape.

The linear projection may be formed continuously or discontinuously on the inner wall of the hose body. In a case where the linear projection is formed discontinuously, two or more linear projections need to be formed so that at least one linear projection is formed in any cross section of the hose perpendicular to the axial direction of the hose body. If there is any cross section in which no linear projection is formed, when an external force is applied to that part of the hose, the fluid passage inside it may be obstructed. In view of the manufacturing process of the hose, of which a description will be given below, it is preferable that the linear projection be formed continuously.

There is no particular restriction on the manufacturing process of a hose according to the present invention; that is, any conventionally known process for manufacturing a hose may be used. Preferred among various manufacturing processes is so-called extrusion molding, whereby a hose is molded continuously by extruding heated and thereby plasticized melted plastic from the tip of a screw provided inside an extruder and then trimming it into a desired cross-sectional shape with a die. Here, a linear projection can be formed integrally on the inner wall of the hose by using, as a means for restricting the internal diameter of the pipe, a cooling mandrel having a groove formed along the axial direction thereof so as to fit the shape of the desired linear projection. Needless to say, the hose body and the linear projection may be formed as separate members and then firmly bonded together. From the viewpoints of bond strength, durability, productivity, and other factors, however, it is preferable that that the linear projection be formed integrally with the hose body.

There is no particular restriction on the size of the hose body of a hose according to the present invention, although there are upper and lower limits associated with the manufacturing process used. By extrusion molding mentioned above, it is possible to manufacture hoses of which the longer sides measure about 5 mm to 1,000 mm. Using a special die and cooling mandrel makes it possible to manufacture even large-size hoses of which the longer sides measure about 500 mm to 3,000 mm.

There is no particular restriction on the material of which the hose body and linear projection of a hose according to the present invention are made, so long as it is elastic. Needless to say, in a case where the hose body and the linear projection are formed integrally, they are formed of the same material. Examples of the material include: synthetic rubber such as styrene-butadiene rubber (SBR), nitrile rubber (NBR), ethylene-propylene rubber (EPR), ethylene-propylene-diene-methylene linkage (EPDM), butyl rubber (IIR), and fluororubber; thermoplastic elastomers such as those based on polystyrene, polyolefin, polyvinyl chloride, polyurethane, polyester, and polyamide; and natural rubber. Among these materials, thermoplastic elastomers are preferred because they can be molded easily on common extruders, particularly preferred among them being polyolefin-based thermoplastic elastomers for their workability, elasticity, hardness, and other properties.

There is no particular restriction on the fluid that is passed through a hose according to the present invention. Preferred examples of the fluid include; liquids such as water, oil, and petroleum refining products; gases such as propane gas and town gas.

Hoses according to the present invention can be used chiefly as hoses for conveying fluid in households, for example as gas hoses and water sprinkling hoses. Moreover, those that have no plasticizer added thereto can be used also as tubes for medical use, for example as catheters. Hoses according to the present invention can be used particularly effectively as hoses that are connected to appliances that do not tolerate variation in the cross-sectional area of the fluid passage inside the hoses, i.e., appliances that do not tolerate variation in the flow rate of fluid. Needless to say, hoses according to the present invention may be used in any other applications than those.

### EXAMPLES

Hereinafter, a practical example of the present invention will be presented. It is to be understood, however, that the example described below is not meant to limit the present invention in any way, and many modifications and variations are possible within the scope of the technical features described in the present specification.

### Practical Example 1

A hose having a cross-sectional shape as shown in FIG. 3A was produced on an extruder by using, as a material, a polyolefin-based elastomer. The longer-side and shorter-side inner dimensions of the hose were 15 mm and 8 mm, respectively; the wall thickness of the hose body was 1.5 mm; and the height of the linear projection was 6 mm. One end of this hose was connected to a faucet of tap water with a fastener, and the other end of the hose was left open. Then, the faucet was opened to let water pass through the hose, and, while the water is vigorously running out of the hose at the open end thereof, the hose, which was placed on a floor, was trodden under the feet of a person having a weight of 65 kg. Through visual checking, no variation was observed in the flow rate of the water running out of the hose at the open end thereof. Even when the hose was bent at an acute angle, no variation was observed in the flow rate of the water running out of the hose at the open end thereof.

### Comparative Example 1

The same tests as those conducted with Practical Example 1 were conducted with a commercially available hose having a circular cross-sectional external shape and having no linear projection formed on its inner wall. The hose was made of the same material as in Practical Example 1. Both when the hose was trodden under the feet of the person and when it was bent at an acute angle, the fluid passage inside the hose was obstructed, and water stopped running out of the hose at the open end thereof.

1. A hose having a hose body of which a cross-sectional external shape as seen in a plane perpendicular to an axial direction is substantially rectangular and having a linear projection formed on an inner wall of the hose body along the axial direction.

2. A hose as claimed in claim 1, wherein a height of the linear projection is 50% or more of a distance from a part of the inner wall on which the linear projection is formed to a part of the inner wall opposite to the linear projection.

3. A hose as claimed in claim 1, wherein the linear projection has a flat surface at a top thereof.

4. A hose as claimed in claim 3, wherein a cross-sectional shape of the linear projection as seen in a plane perpendicular to an axial direction is trapezoidal.

5. A hose as claimed in claim 2, wherein a gap between a top of the linear projection and the part of the inner wall opposite to the linear projection is in a range from 5% to 30% of the distance from the part of the inner wall on which the linear projection is formed to the part of the inner wall opposite to the linear projection.

6. A hose as claimed in claim 2, wherein a gap between a top of the linear projection and the part of the inner wall opposite to the linear projection is in a range from 10% to 28% of the distance from the part of the inner wall on which the linear projection is formed to the part of the inner wall opposite to the linear projection.

7. A hose as claimed in claim 1, wherein two or more linear projections are formed on opposite parts of the inner wall in such a way that tops of the linear projections point each other.

8. A hose as claimed in claim 7, wherein a sum of heights of the opposite linear projections is 50% or more of a distance between parts of the inner wall on which the linear projections are formed.

9. A hose as claimed in claim 7, wherein a gap between the tops of the opposite linear projections is in a range from 5% to 30% of a distance between parts of the inner wall on which the linear projections are formed.

10. A hose as claimed in claim 7, wherein a gap between the tops of the opposite linear projections is in a range from 10% to 28% of a distance between parts of the inner wall on which the linear projections are formed.
